(19) United States
(12) Patent Application Publication
(10) Pub. No.: US 2016/0013497 A1
(43) Pub. Date: Jan. 14, 2016

(54) IMPROVED ELECTRODE FOR FLOW BATTERIES

(71) Applicant: GRAFTECH INTERNATIONAL HOLDINGS INC., Parma, OH (US)

(72) Inventors: Lawrence K. Jones, Parma, OH (US); Haiming Xiao, Copley, OH (US)

(21) Appl. No.: 14/771,295

(22) PCT Filed: Jan. 30, 2014
(86) PCT No.: PCT/US14/13823

§ 371 Date: Aug. 28, 2015

Related U.S. Application Data
(60) Provisional application No. 61/789,150, filed on Mar. 15, 2013.

(51) Int. Cl. H01M 4/96; H01M 8/20; C01B 31/12; H01M 8/18

(52) U.S. Cl. CPC H01M 4/96; H01M 8/188; H01M 8/20; C01B 31/12

(57) ABSTRACT

An electrode for a flow battery includes a carbonized felt having a bulk density of from between about 0.05 g/cc and about 0.2 g/cc and a dry weight and an equilibrium weight after submersion in an electrolyte. The carbon felt receives a treatment that enables an equilibrium weight at least 20 times the dry weight.

### RELATED APPLICATIONS

This application is the U.S. National Phase under 35 U.S.C. §371 of International Application No. PCT/US2014/013823, filed on Jan. 30, 2014, which claims the benefit of U.S. Provisional Application 61/789,150 filed Mar. 15, 2013, with the title of Portable Improved Electrode For Flow Batteries, the disclosures of which Applications are incorporated herein in their entirety by reference.

A flow battery is a type of fuel cell in which an electrolyte flows through an electrochemical cell. The cell reversibly converts chemical energy to electricity. The electrolyte is generally a liquid which is stored in tanks, and is pumped through the cells of the battery. Recharging can be performed by simply replacing the electrolyte fluid if no power source is available for charging.

The vanadium redox battery is a type of rechargeable flow battery that employs vanadium ions in different oxidation states to store chemical potential energy. The vanadium redox battery operates based on the capability of vanadium to exist in solution in four different oxidation states. One advantage of the vanadium redox battery design is that it can offer very large capacity through the use of large storage tanks that can be in a discharged state for long periods without the common ill effects found in other battery technologies.

A vanadium redox battery commonly includes an assembly of power cells wherein two electrolytes are separated by a proton exchange membrane. Both electrolytes are vanadium based, the electrolyte in the positive cells contain VO₂⁺ and VO²⁺ ions and the electrolyte in the negative cells contain V³⁺and V²⁺ ions. The electrolytes may be prepared by any number of processes. For example, one approach includes electrolytically dissolving vanadium pentoxide (V₂O₅) in sulfuric acid (H₂SO₄). The resulting solution is typically strongly acidic.

In vanadium flow batteries, each half-cell is connected to a storage tank and pump so that large volumes of the electrolytes can be circulated through the cell. When a vanadium battery is charged, the VO²⁺ ions in the positive cell are converted to VO₂⁺ ions as electrons are removed from the positive terminal of the battery. Likewise, in the negative cell, electrons are introduced converting the V³⁺ ions into V²⁺.

### SUMMARY OF THE INVENTION

According to one aspect, an electrode for a flow battery includes a carbonized felt has a bulk density of from between about 0.05 g/cc and about 0.2 g/cc and has a dry weight and an equilibrium weight after submersion in an electrolyte. The equilibrium weight is at least 20 times the dry weight.

According to another aspect, an electrode for a flow battery has an electrolyte as a working fluid. The electrode includes a carbonized felt material having a bulk density of from between about 0.05 g/cc and about 0.2 g/cc. A 0.75 cm thick portion of the carbonized felt material submerges under force of gravity in the electrolyte in less than 15 seconds.

According to yet another aspect, a method of making an electrode for a flow battery includes providing a carbon felt having a bulk density from between about 0.05 g/cc and about 0.2 g/cc. The carbon felt is exposed to an acid solution. The carbon felt is further heat treated to at least 300 degrees C. for at least one hour.

### BRIEF DESCRIPTION OF THE DRAWINGS

FIG. 1 is a partially schematic view of a flow battery in accordance with the present invention.

FIG. 2 is a partially schematic view of a multi-cell flow battery in accordance with the present invention.

### DETAILED DESCRIPTION

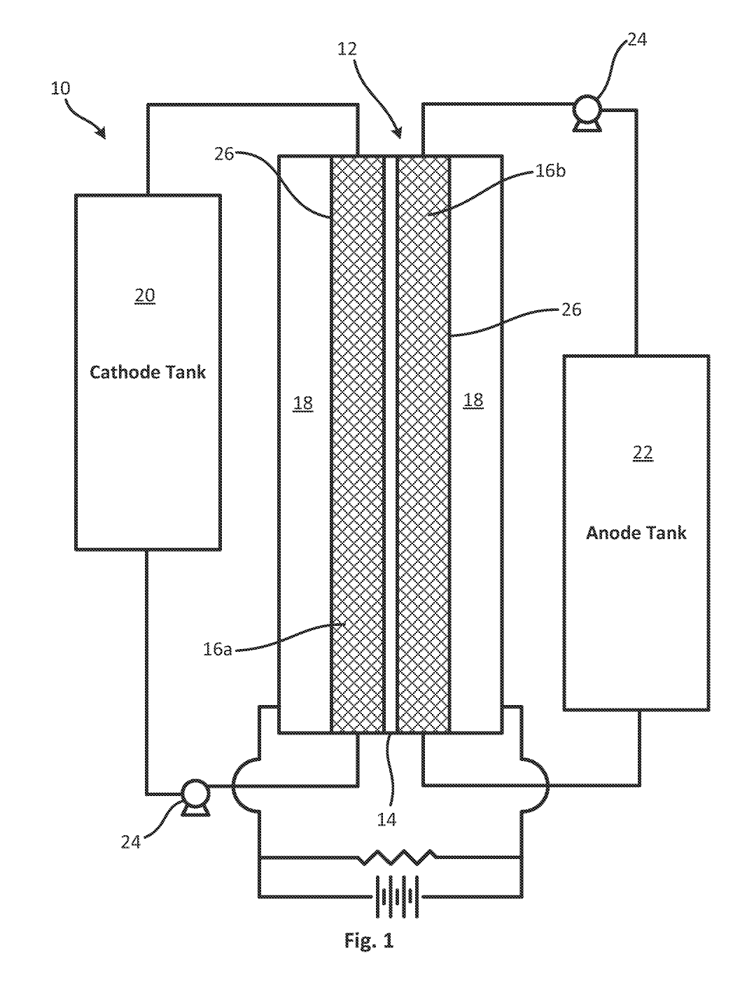

A single-cell vanadium redox battery is shown and described in FIG. 1 and generally indicated by the numeral 10. Each cell 12 includes a proton exchange membrane 14 positioned between opposing electrodes 16. On the opposed side of each electrode 16 from the membrane 14 is a plate 18 (also commonly referred to as a bipolar plate). A first tank 20 includes a first electrolyte fluid and a second tank 22 includes a second electrolyte fluid. First tank 20 is in fluid connection with the first electrode 16a and second tank 22 is in fluid connection with the second electrode 16b. A pump 24 selectively draws the electrolyte fluid from the tanks 20/22 and through electrodes 16 to create an operating current.

Likewise, a current may be applied to the cell 12 while pumping electrolyte fluid there through to “charge” the battery.

The membrane 14 is a proton exchange membrane. Membrane 14 separates the two electrolytes (creating a positive and negative side) but allows the transfer of H⁺ there through to keep the cell conductive. Membrane 14 may advantageously be made from, for example, Nafion.

The electrode 16 is a generally porous material that allows the electrolyte fluid to flow through while enabling the electrochemical reaction that creates the working charge from the battery. In one particularly preferred embodiment, electrode 16 is a porous carbon material. In particular, a carbon fiber matrix or felt has been shown to be particularly suitable to this application given the chemical resistance and relatively high electrical conductivity. Fibers may advantageously be carbonized rayon-based fibers. In other embodiments, the fibers may be carbonized PAN-based fibers. In still other embodiments, the fibers may be derived from carbonized pitch fibers or carbonized fibers from other petroleum based products. In still further embodiments, the carbonized fibers may be derived from plant derived cellulose fibrils such as lignen.

Electrode 16 has a bulk density of from between about 0.05 g/cc to about 0.2 g/cc. In other embodiments, the electrode 16 bulk density is from between about 0.06 g/cc to about 0.08 g/cc. In still other embodiment, the electrode treatments described herein below allow for electrode bulk density to be at least 0.08 g/cc, more advantageously at least 0.1 g/cc and still more advantageously at least 0.15 g/cc.

Plates 18 are advantageously formed of a graphite sheet material. A common method for manufacturing graphite sheet is described by Shane et al. in U.S. Pat. No. 3,404,061, the disclosure of which is incorporated herein by reference. In one method, natural graphite flakes are intercalated by dispersing the flakes in an intercalation solution. The intercalation solution contains oxidizing and other intercalating agents known in the art such as nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid.

The thus treated particles of graphite are sometimes referred to as “particles of intercalated graphite”. Upon exposure to high temperature, e.g. about 700° C. to 1000° C. and higher, the particles of intercalated graphite expand as much as about 80 to 1000 or more times its original volume in an accordion-like fashion in the c-direction, i.e. in the direction perpendicular to the crystalline planes of the constituent graphite particles. The expanded, i.e. exfoliated graphite particles are vermiform in appearance, and are therefore commonly referred to as worms. The worms may be compressed together into flexible sheets that, unlike the original graphite flakes, can be formed and cut into various shapes.

The graphite sheet is coherent, with good handling strength, and are suitably compressed, e.g. by roll-pressing, to a thickness of about 0.075 mm to 3.75 mm, more advantageously from between about 0.2 to about 1.5 mm, and still more advantageously from between about 0.4 mm and about 1.0 mm. The graphite sheet for use in the bipolar plate advantageously has a density of about 1.0 to 2.0 grams per cubic centimeter, more advantageously from between about 1.5 to 2.0 grams per cubic centimeter. In still further embodiments, the graphite sheet advantageously has a density greater than about 1.5 grams per cubic centimeter and even more advantageously greater than about 1.8 grams per cubic centimeter.

The graphite sheet is advantageously treated with resin and the absorbed resin, after curing, enhances the moisture resistance and handling strength, i.e. stiffness of the flexible graphite sheet. Suitable resin systems may be, for example, epoxy based or polyimide based. Suitable resin content is preferably from between about 5 to 50% by weight, and more preferably between about 10 and about 40% by weight. In this or other embodiments, the resin content may be up to about 60% by weight. The resin density may be from between 1.0 g/cc to 1.5g/cc depending upon the resin. The density of the graphite sheet after resin impregnation may be from between about 1.5 g/cc to about 2 g/cc. In still other embodiment the graphite sheet after resin impregnation may be from between about 1.6 g/cc to about 1.8 g/cc.

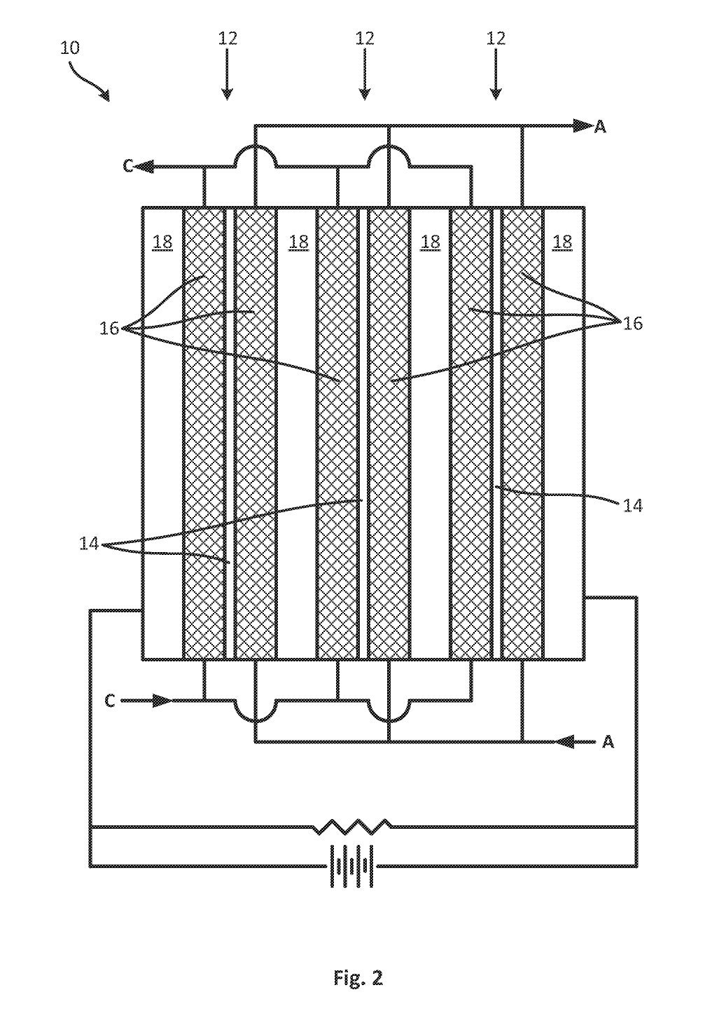

With reference now to FIG. 2, a multi-cell vanadium redox battery is shown and generally indicated by the numeral 100, and where like numerals indicate like elements. The multi-cell battery functions substantially the same as the single cell variant, except that multiple cells 12a, 12b, and 12c are positioned in a stacked arrangement. In this manner, the current generated through operation of the battery 100 is produced in series by cells 12, which allows higher power applications.

When in use, as the electrolyte fluid flows through electrodes 16, an electrical potential is created across the electrodes 16. The electrodes 16 are operatively electrically connected to an operating circuit. In practice, the electrical current generated in electrodes 16 is passed to the adjacent plates 18 at an electrode interface 26. Advantageously, the opposed major surfaces of the electrode 16 and of the plate 18 are substantially the same size and profile. In other embodiments, advantageously at least 70 percent, more advantageously 80 percent, and still more advantageous at least 95 percent of the surface area of the plates 18 engages the surface of the electrode 16. The plate 18 may in turn be electrically connected to the operating circuit directly, through current collectors at the end of a stack of cells (not shown), or to another electrode in the case of stacked multi-cell batteries.

Performance is advantageously improved if reduced electrical contact resistance at the electrode interface 26 is achieved. Indeed, reduced contact resistance leads to lower voltage loss across the interface 26, which in turn leads to higher battery power output. Advantageously, the plate 18 is generally sheet or plate shaped, and thus includes opposed major surfaces. Advantageously, at least one major surface of plate 18 receives a surface treatment which reduces electrical resistance at the interface. The thus treated surface being adjacent to and in contact with an electrode 16 to form the electrode interface 26. In other embodiments, both major surfaces of the plate 18 include a surface treatment.

According to one aspect of the present invention the surface treated plate 18 is made according to the following method. A resin impregnated compressed exfoliated natural graphite sheet is made in accordance with the description above. Thereafter, a surface treatment is performed on the surface of the plate 18 that contacts the electrode 16. The surface treatment preferably increases contact surface area and consequentially reduces interfacial surface energy at interface 26. Surface treatment advantageously includes a roughening operation. Examples of roughening operations may include one or more of, low power sand-blasting, abrasive paper treatment, falling sand brush, and chemical etching treatments.

For purposes of this disclosure, surface roughness measurements (mean max height and arithmetic mean roughness) are performed using a Mahr Meter having a traversing detector distance of 0.224 in. In one embodiment, the surface treatment results a greater surface roughness of the resin impregnated graphite sheet. Resin impregnated, compressed exfoliated natural graphite plates 18, prior to surface treatment, may exhibit an arithmetic mean roughness of from between about 5 μ-in to about 50 μ-in, more preferably from between about 15 μ-in to about 40 μ-in, and still more preferably from between about 20 μ-in to about 35 μ-in. Resin impregnated, compressed exfoliated natural graphite plates, prior to surface treatment may exhibit an arithmetic mean roughness of less than 100 μ-in, more preferably less than about 50 μ-in, still more preferably less than about 30 μ-in.

Still further, resin impregnated, compressed exfoliated natural graphite plates, prior to surface treatment, exhibit a mean max height of profile from between about 100 μ-in to about 200 μ-in, more preferably from between about 120 μ-in to about 180 μ-in, and still more preferably from between about 130 μ-in to about 170 μ-in. Resin impregnated, compressed exfoliated natural graphite plates, prior to surface treatment may exhibit a mean maximum height of profile less than 200 μ-in, more preferably less than about 180 μ-in, still more preferably less than about 170 μ-in.

Resin impregnated, compressed exfoliated natural graphite plates, after surface treatment, may exhibit an arithmetic mean roughness of from between about 100 μ-in to about 500 μ-in, more preferably from between about 200 μ-in to about 400 μ-in, and still more preferably from between about 250 μ-in to about 350 μ-in. Resin impregnated, compressed exfoliated natural graphite plates, after surface treatment may exhibit an arithmetic mean roughness of greater than 100 μ-in, more preferably greater than about 200 μ-in, still more preferably greater than about 300 μ-in.

Still further, resin impregnated, compressed exfoliated natural graphite plates, after surface treatment, exhibit an mean max height of profile from between about 1000 μ-in to about 2500 μ-in, more preferably from between about 1200 μ-in to about 2000 μ-in, and still more preferably from between about 1300 μ-in to about 1700 μ-in. Resin impregnated, compressed exfoliated natural graphite plates, after surface treatment may exhibit a mean maximum height of profile greater than 1000 μ-in, more preferably greater than about 1250 μ-in, still more preferably greater than about 1500 μ-in.

Advantageously, the ratio of arithmetic mean roughness after vs prior to surface treatment (roughness after treatment/roughness before treatment) is preferably at least 3 or more, more preferably at least 5 and still more preferably at least 10. Likewise, the ratio of mean maximum height of profile after vs prior to surface treatment (mean max height after treatment/mean max height before treatment) is preferably at least 3 or more, more preferably at least 5 and still more preferably at least 10.

Advantageously electrode 16 receives a treatment that reduces hydrophobic characteristics (relative to the electrolyte) and therefore makes the electrode relatively more hydrophilic as compared to untreated electrodes. As discussed above, the electrode 16 is a carbon fiber felt. The treatment includes exposure of the carbon fiber electrode to an acid solution. In one embodiment, the acid is an organic acid, more advantageously a carboxylic acid and still more advantageously a Brønsted-Lowry acid, such as, for example oxalic acid. In other embodiment's the acid may a metallic acid such as, for example sulfuric acid. The acid solution may have a PH of from between about 1.0 and about 5.0. In still further embodiments, the acid solution may be a combination of organic and metallic acids.

Organic acids are typically less soluble in water and therefore may be from between about 2 and about 10 percent. In other embodiments, the organic acid concentration may be from between about 2 and about 5 percent concentration. In still other embodiments, the organic acid concentration may be less than about 15 percent. Acid solutions of metallic acids are generally higher and may be advantageously greater than 50 percent, more advantageously greater than 75 percent and still more advantageously may be greater than about 90 percent concentration. At room temperature, residence time in the acid bath of the high concentration metallic acids (greater than 90 percent concentration) are less than about 60 minutes, more advantageously less than about 30 minutes and still more advantageously less than about 15 minutes. At room temperature, residence time in the acid bath of the low concentration organic acids (less than 10 percent concentration) are greater than about 3 hours, more advantageously greater than about 4 hours and still more advantageously greater than about 5 hours. At room temperature, residence time in the acid bath of the low concentration organic acids (less than 10 percent concentration) may be from between about 4 and about 8 hours. In other embodiments, the residence time in the acid bath of the low concentration organic acids (less than 10 percent concentration) may be from between about 5 and about 7 hours.

The electrodes 16 are further advantageously subjected to a heat treatment step before the acid treatment, after the acid treatment or both before and after the acid treatment. Heat treatment may include heating the electrode 16 in air to from between about 250 degrees C. and about 600 degrees C. In other embodiments, the heat treatment may be from between about 300 degrees C. and about 500 degrees C. In other embodiments, the heat treatment may be from between about 350 degrees C. and about 450 degrees C. In still further embodiments, the heat treatment is at least 300 degrees C. In other embodiments the heat treatment is at least 400 degrees C. The heat treatment advantageously holds the maximum temperature for at least one hour, more advantageously at least three hours and still more advantageously at least five hours.

The acid treatment combined with heat treatment significantly increases the hydrophilic characteristics of the carbon felt electrode 16. This in turn reduces pressure drop across the electrode in the flow battery so that parasitic pumping energy loss is minimized Further, the treated electrode more easily absorbs the electrolyte fluid so that gas evolution (i.e. hydrogen evolution) within the electrode is reduces, which further improves performance. In one embodiment, the equilibrium weight pickup (as described herein below) of the electrode 16 is increased by at least 10 percent compared to non-treated electrodes. In other embodiments, the weight pickup is increased by at least 20 percent compared to non-treated electrodes. In still further embodiments, the weight pickup is improved at least 30 percent compared to non-treated electrodes. The electrode weight pickup is measured by submerging a 0.75 cm thick electrode material in electrolyte solution and periodically removing the sample and weighing it. The samples when submerged were at 1.5 inch of water column. In this or other embodiments, the electrode weight of a treated electrode after equilibrium is at least 20 times, more advantageously at least 21 times, still more advantageously at least 22 times and still more advantageously at least 25 times the original electrode weight.

According to another aspect, the treated electrode wettability may be characterized by the speed at which it becomes completely submerged under its own weight in an electrolyte solution. Advantageously, the electrode totally submerges in less than one minute, more advantageously less than 30 seconds and still more advantageously less than 15 seconds.

### EXAMPLE 1

Data was collected to compare the wettability (as characterized by weight pickup etc) of a 0.75 cm thick carbonized rayon felt having a bulk density of approximately 0.6 g/cc. The electrode material was submersed in a 5% oxalic acid solution for six hours, followed by drying and a heat treatment at 400 degrees for five hours in an air atmosphere.

The first experiment compared electrolyte weight pickup as a function of time. The electrolyte was 1.68 molar V⁴⁺ added to 2.5 molar H₂SO₄, remainder being water. The treated sample was weighed at 0.5, 5, 10, and 20 seconds. The weight stabilized in 10 seconds and achieved 95% of the total weight pickup in 0.5 seconds. Weight pickup (i.e. final weight minus dry weight) was 6.52 grams with an original weight 0.31 grams. The untreated sample was weighed at 0.5, 10, 20, 60, 120, 240 and 360 seconds. The weight of the untreated electrode stabilized at 120 seconds with a weight pickup of 5.23 grams. The weight pickup at equilibrium of the treated sample was therefore approximately 20% greater than the untreated sample. Further, the equilibrium was reached 12 times faster.

In a second experiment the treated and untreated electrode wettability was characterized by the speed at which it becomes completely submerged under its own weight in an electrolyte solution. The treated sample became totally submerged in 10 seconds. The untreated sample floated on the surface for 48 hours with no weight pickup.

As can be seen, the treated electrode exhibits hydrophilicity to electrolyte fluids and allows faster weight pickup of electrolyte. The untreated felt exhibits hydrophobicity and a slow weight pickup of electrolyte. It should be appreciated that, though the present disclosure is focused on vanadium redox batteries, the above described improved electrodes may be used in other types of flow batteries.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

We claim:

1. An electrode for a flow battery comprising:
a carbonized felt having a bulk density of from between about 0.05 g/cc and about 0.2 g/cc and having a dry weight and an equilibrium weight after submersion in an electrolyte, wherein said equilibrium weight is at least 20 times said dry weight.

2. The electrode according to claim 1 wherein said equilibrium weight is at least 21 times said dry weight.

3. The electrode according to claim 1 wherein said equilibrium weight is at least 22 times said dry weight.

4. The electrode according to claim 1 wherein said bulk density is at least about 0.1 g/cc.

5. The electrode according to claim 1 wherein said carbonized felt is a carbonized rayon fiber material.

6. The electrode according to claim 1 wherein said carbonized felt is a carbonized PAN fiber material.

7. The electrode according to claim 1 wherein said carbonized felt is a carbonized pitch fiber material.

8. The electrode according to claim 1 wherein said carbonized felt is a carbonized lignin fiber material.

9. An electrode for a flow battery having an electrolyte as a working fluid, the electrode comprising:
a carbonized felt material having a bulk density of from between about 0.05 g/cc and about 0.2 g/cc and wherein a 0.75 cm thick portion of said carbonized felt material submerges under force of gravity in said electrolyte in less than 15 seconds.

10. The electrode according to claim 9 wherein said bulk density is at least about 0.1 g/cc.

11. The electrode according to claim 9 wherein said bulk density is at least about 0.15 g/cc.

12. The electrode according to claim 1 wherein said carbonized felt is a carbonized rayon fiber material.

13. The electrode according to claim 1 wherein said carbonized felt is a carbonized PAN fiber material.

14. The electrode according to claim 1 wherein said carbonized felt is a carbonized pitch fiber material.

15. The electrode according to claim 1 wherein said carbonized felt is a carbonized lignin fiber material.

16. A method of making an electrode for a flow battery comprising:
providing a carbon felt having a bulk density from between about 0.05 g/cc and about 0.2 g/cc;
exposing said carbon felt to an acid solution; and
heat treating said carbon felt to at least 300 degrees C. for at least 1 hour.

17. The method of making an electrode according to claim 16 wherein said acid solution comprises an organic acid.

18. The methods of making an electrode according to claim 17 wherein said organic acid comprises oxalic acid.

19. The method of making an electrode according to claim 16 wherein said carbon felt has a bulk density from between about 0.06 g/cc and about 0.08 g/cc.

20. The methods of making an electrode according to claim 16 wherein said carbon felt has a bulk density of at least 0.1 g/cc.

21. A method of making an electrode according to claim 16 wherein said heat treating step is performed after said step of exposing said carbon felt to an acid solution.
